(19) United States
(12) Patent Application Publication
(10) Pub. No.: US 2013/0127340 A1
(43) Pub. Date: May 23, 2013

(54) MOTOR VEHICLE LIGHT, MOTOR VEHICLE AND METHOD FOR OPERATING A MOTOR VEHICLE LIGHT

(71) Applicant: Audi AG, Ingolstadt (DE)

(72) Inventors: Wolfgang Huhn, Reichertshofen (DE); Manfred Stadtler, Neuburg (DE); Mona Freudenberger, Bad Rappenau (DE)

(73) Assignee: Audi AG, Ingolstadt (DE)

(21) Appl. No.: 13/652,918

(22) Filed: Oct. 16, 2012

(30) Foreign Application Priority Data
Nov. 23, 2011 (DE) 10 2011 119 231.3

(51) Int. Cl. B60Q 1/02; F21V 13/02; F21V 8/00

(52) U.S. Cl. 315/77; 362/511

(57) ABSTRACT

A motor vehicle light providing easily identifiable and interpretable signals for other road users includes in its interior a light guide which is configured to receive at least a part of a light from a light source, distributes the received light along a light exit face and scatters the distributed light toward the light exit face. The light source is composed of light-emitting diodes which are switched on sequentially and/or which are first supplied with different electrical power levels, whereafter their brightness is matched by controlling the power levels. When the motor vehicle light is switched on, the increase in brightness then appears to be continuous to an observer.

### CROSS-REFERENCES TO RELATED APPLICATIONS

This application claims the priority of German Patent Application, Serial No. 10 2011 119 231.3, filed Nov. 23, 2011, pursuant to 35 U.S.C. 119(a)-(d), the content of which is incorporated herein by reference in its entirety as if fully set forth herein.

### BACKGROUND OF THE INVENTION

The present invention relates to a motor vehicle light for a motor vehicle, in which light can be generated by a light source and emitted to the outside by passing through a light exit face. The invention also relates to a method for operating a motor vehicle light and a motor vehicle with a motor vehicle light.

The following discussion of related art is provided to assist the reader in understanding the advantages of the invention, and is not to be construed as an admission that this related art is prior art to this invention.

It is desirable in the interests of road safety that motor vehicles, i.e. road vehicles such as cars or trucks, alert other road users to an impending change in the driving behavior of the vehicle as clearly as possible and with little delay. For this purpose, a motor vehicle includes motor vehicle lights, such as turn signals (direction indicator lights) and brake lights. To indicate a change in the driving situation as quickly as possible with these motor vehicle lights, light-emitting diodes (light-emitting diodes) are nowadays used as illumination means in these vehicle lights. These light-emitting diodes attain their full brightness in less than 10 ms. Conversely, light bulbs require a time between 150 ms and 200 ms. When using light-emitting diodes, the light exit face of the motor vehicle light thus attains its full brightness almost instantaneously after being switched on. However, such an instantaneous change has not only advantages. Especially in confusing traffic situations with many road users, a driver is frequently unable to pay attention to all vehicles simultaneously. When he turns his attention briefly away from one of the vehicles and a motor vehicle light of that vehicle is turned on at this moment, the driver does not see this transition. After looking back to the vehicle, the driver sees a changed, but static image of the vehicle. With a very large number of vehicles, the driver may possibly not become aware of the change. He thus has missed the transition lasting only a few milliseconds during which his attention could have been drawn to the vehicle.

Another striking, but not always desirable characteristic of light-emitting diodes as light sources is that they are not as bright as for example xenon lamps. Several light-emitting diodes must therefore always be arranged in a matrix and operated simultaneously. Instead of a uniformly illuminated light exit face of the motor vehicle light, a viewer then sees a matrix composed of bright spots. The distance between these points must not be so large so that a viewer no longer perceives the accumulation of these bright points as a single lamp that should indicate something to the viewer. Accordingly, a large number of light-emitting diodes is thus necessary for large light exit faces, although the brightness from a smaller number of light-emitting diodes would suffice.

In the context of indicating more clearly an impending change in the driving direction with a turn signal, a series of lamps of a turn signal may be turned on sequentially, thus producing a moving light effect or animation effect in the turn signal. However, indicating a change in direction by means of a moving light is not legal in all countries. For example, the ECE regulations (ECE—Economic Commission for Europe) stipulate that the flashing region of a turn signal must have a fixed relationship with respect to the vehicle while the turn signal is activated. In other words, the illuminated area—while flashing—is not permitted to move from one side to the other in the turn signal due to a moving light effect.

It would therefore be desirable and advantageous to obviate prior art shortcomings and to produce in a motor vehicle improved light signals that can be easily recognized and interpreted by other road users.

### SUMMARY OF THE INVENTION

According to one aspect of the present invention, a motor vehicle light includes a light source producing light, a light exit face through which the produced light is emitted to the outside, and a light guide made of a transparent material and configured to receive at least a portion of the light from the light source, to distribute the received light along the light exit face, and to scatter the distributed light toward the light exit face.

According to another aspect of the present invention, a method for operating a motor vehicle light includes increasing—during a light-up phase—a total light intensity, which is emitted in by the motor vehicle light through a designated total light exit face, so as to appear continuous to a human observer by at least one of the following two processes: a) successively switching on a plurality of light-emitting diodes of the motor vehicle light, and b) initially supplying a plurality of light-emitting diodes with different levels of electric power and subsequently controllably adjusting the electric power to match the brightness of the plurality of the light-emitting diodes to one another.

The present also relates to a motor vehicle light with the aforedescribed light source, and a control unit which is configured to operate the motor vehicle light according to the aforedescribed method, and to a motor vehicle with the aforedescribed light source and aforedescribed the control unit. No modifications may be required on the rest of the motor vehicle. The control unit may be realized, for example, with a microcontroller.

According to method of the present invention, the total light exit face is not instantaneously filled with light when a motor vehicle light is switched on, but is instead filled with light over a predetermined period of time. The total light exit face, here the lens, becomes in this case gradually brighter with time in the light-up phase and/or an illuminated portion of the total exit area becomes larger with time. The inventive drive thereby enables the generation of the light-up phase also with light-emitting diodes without sacrificing the time benefit that can be achieved due to the short light-up time the light-emitting diodes when indicating a changed driving situation.

According to an advantageous feature of the present invention, when the lamp in a motor vehicle is switched on in a light-up phase, the brightness of the emitted light increases for a human observer in a process perceived as continuous. For this purpose, a plurality of light-emitting diodes of the lamp is switched on successively. Instead of or in addition to this staggered switching, the light-emitting diodes may initially be supplied with different electrical power, so that at least one bright light-emitting diode and several darker light-emitting diodes are visible from the start. The brightness is thereafter matched by a controlled adjustment of the power levels.

According to an advantageous feature of the present invention, at least some of the light-emitting diodes may thus be switched on instantaneously, when the motor vehicle light receives the corresponding signal. Additional light-emitting diodes may then be switched on or their power level may be steadily increased. By controlling the process so that it appears continuous to a viewer, a viewer has a smooth impression of motion without abrupt transitions which the viewer may overlook, for example, when flashing. Such smooth transitions have the physiological effect that they arouse the attention of an observer. Due to the time component, a viewer requires even less viewing time to recognize the change. Another not insignificant advantage is the attractive creation of the motor vehicle light by a light-up phase.

According to an advantageous feature of the present invention, for increasing for a human observer the impression that the brightness continuously increases, when individual light-emitting diodes are sequentially switched on, two successively switched light-emitting diodes should be switched on with a time offset of less than 60 ms, in particular less than 45 ms. This produces an effect also known from movies, where the individual images of a film are switched within 40 ms, thereby creating “moving images”.

According to another advantageous feature of the present invention, a number of different types of the motor vehicle lights designed for signaling may be provided with the method of the invention, in particular motor vehicle lights that provide at least one of the following functionalities: a turn signal, a brake light, a daytime moving light, a position light, and a tail light.

As explained above, there are legal restrictions in particular for turn signals that no moving light effect may be shown. To this end, according to an advantageous feature of the present invention, a time period of the light-up phase may be in a range 100 ms to 200 ms, in particular in a range of 100 ms to 160 ms. In other words, the total light-up phase may not last longer than the time for a light bulb to attain its full brightness. A time profile of the light intensity of the total light emitted is then not different from that of a conventional motor vehicle light operated with an incandescent lamp. Thus, even if a moving light effect or other animated impression is created for the viewer on the basis of the inventive method, this effect does not take more time than switching on a conventional motor vehicle light with bulb and thus remains within the legal requirements.

Accordingly, it is therefore possible within the legal requirements to switch the light-emitting diodes on sequentially in the light-up phase and to thereby continuously increase an illuminated part of the total light exit face in the light-up phase, so that the total light exit area is continuously filled with light. This effect of filling the total light exit area is perceived by the observer as animation, which may, for example, also indicate a pending change of direction. A continuously increasing illuminated portion of the total light-emitting exit area relates, in particular, to a spatially contiguous portion.

According to another advantageous feature of the present invention, to particularly clearly encode direction information in the manner described above and to thereby operate the motor vehicle light as a flashing light, a plurality of light-emitting diodes which are arranged in a line or row adjacent to each other are operated as follows: At the start of a flashing cycle, individual light-emitting diodes or also groups of light-emitting diodes may be switched on in a light-up phase. For this purpose, starting from an initial group of light-emitting diodes that includes at least one of the light-emitting diodes from the row of light-emitting diodes, additional light-emitting diodes of the row may be sequentially switched on one after the other either individually or in groups of several adjacent light-emitting diodes. In other words, a continuously lengthening line or row of illuminated light-emitting diodes is thus formed in the light-up phase of the flashing cycle. Lastly, an end group row of the remaining light-emitting diodes located at the end of the row may be switched on, lighting up all light-emitting diodes of the row. The light-up phase is thereby completed. The row of the light-emitting diodes may be left switched on, for example for 400 ms, and may thereafter remain switched off for half a second before the next flashing cycle begins.

Time-sequential control of the individual groups of light-emitting diodes requires control of respective switches for the individual light-emitting diode groups. This may be accomplished, for example, with a microcontroller. However, problems may arise with motor vehicle lights composed of at least two structurally separate parts. One example of such a motor vehicle light is a tail light. According to an advantageous feature of the present invention, one part may be provided for installation in a tailgate of the motor vehicle and another part for installation in a side wall of the vehicle adjoining the tailgate. To eliminate the need for two microcontrollers (one for each one of the components of the motor vehicle light), according to an advantageous feature of the method for operating sequentially arranged by the emitting diodes, even when the row of light-emitting diodes may extend over the at least two structurally separate parts of the motor vehicle, the light-emitting diodes disposed in one of the parts may always be operated as the initial group or the end group at the same time. In other words, all light-emitting diodes of the row of one of the parts of the motor vehicle light may be switched at the same time as a light-emitting diode group. A separate microcontroller configured to sequentially turn on the light-emitting diodes may then be eliminated in this component of the motor vehicle light. Another advantage is that the component, where the light-emitting diodes are switched simultaneously, then always appears as a conventional turn signal without a moving light effect.

According to an advantageous feature of the present invention, a smooth transition between the structurally separate parts of the motor vehicle light in light-up phase may be achieved by transmitting a handshake signal between two adjacent parts of the motor vehicle light, after all the light-emitting diodes of one of the parts have been switched on. The handshake signal then represents a trigger signal for seamlessly turning on the light-emitting diodes of the other part.

As already mentioned, individual light-emitting diodes need not always be turned on sequentially. Instead, entire groups of light-emitting diodes may be turned on simultaneously. The number and placement of light-emitting diodes of a group then determines the size of the area as part of total output exit area that lights up when this group is switched on. When relatively large partial areas are to be turned on, this may result in an increased circuit complexity, which in turn may result in undesirably high cost. According to another advantageous feature of the present invention, a light source may be provided in this context in a motor vehicle light, wherein light is distributed in the motor vehicle light by a light guide. The light guide may be configured to receive at least a portion of light from a light source, to distribute the received light along the light exit face and to scatter the distributed light along the light exit face. In the inventive motor vehicle light, the light source thereby does not emit light to the outside directly through the light exit face.

Instead, the light is first distributed by the light guide along, i.e. parallel to, the light exit face and then emitted to the outside after having been distributed over a larger area. This is possible with a single light source without added circuit complexity. In contrast to using light-emitting diodes interconnected into groups, the use of a light guide has the additional advantage that no point-like light areas on the light exit face can be perceived from the outside. The light can be emitted by way of the light guide with a uniform distribution and with a uniform intensity. The optical waveguide distributes light preferably over a length of at least 4 cm along the lens.

The motor vehicle light according to the invention is advantageously operated with light-emitting diodes, but may also be operated with other light sources, such as xenon lamps, or other gas discharge lamps or incandescent lamps.

To avoid scattering losses in the light guide, the light should be deflected as seldom as possible. According to another advantageous feature of the present invention, the light source may have a main emission direction in which the light source emits light with maximum intensity. For example, light-emitting diodes may represent a light source with a particularly highly directional radiation pattern. The light source is then arranged in the motor vehicle light such that the main emission direction includes with the light exit face an angle in a range from 0° to 50°, in particular in a range from 0° to 30° with the light source, and thus radiates its light not into the direction in which the light exits from the light exit face of the motor vehicle light. Instead, the light source radiates transversely thereto, which makes it easier to distribute the light along the light exit face with the light guide.

The light guide may be the lens of the motor vehicle light itself, meaning the lens which includes the light exit face and which delimits the motor vehicle light to the outside. According to another advantageous embodiment of the motor vehicle light, the light guide includes a body made of a material that is transparent to the light and arranged behind the lens. Such a separate component can then be readily integrated into existing types of motor vehicle lights without requiring extensive redesign of these lights.

By distributing the light from the light source, the brightness distribution on the light exit face becomes more uniform. The light may, however, possibly appear darker in some areas. According to an advantageous feature of the present invention, this effect is compensated in one embodiment of the motor vehicle light by introducing light into the light guide at two different ends of the light guide and by using at least one light source.

To obviate the need for distributing light from the light sources over a large area for a uniform illumination of the light exit face, or for illuminating in accordance with the aforedescribed method of the invention individual components of the overall light exit face sequentially in time, a plurality of light guides of the aforementioned type may be provided in the inventive motor vehicle light. A predetermined region of the light exit face can then be illuminated with each of the light guides independent of the other areas.

Also, in the context of the motor vehicle light according to the invention, the motor vehicle light may provide different functions when signaling driving situations. These may be, for example: a turn signal, a daytime running light, a position light, a tail light, and a brake light.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows in the top part of the figure a schematic diagram of a first exemplary embodiment of a motor vehicle light, and in the bottom part of the figure a timing diagram according to an embodiment of the method according to the present invention;

FIG. 2 shows in the top part of the figure a schematic diagram of a second exemplary embodiment of a motor vehicle light with a lens, and in the bottom part of the figure a timing diagram according to an embodiment of the method according to the present invention;

FIG. 3 shows in the top part of the figure a schematic diagram of a third exemplary embodiment of a motor vehicle light with a lens, and in the bottom part of the figure a timing diagram according to an embodiment of the method according to the present invention; and

FIG. 4 shows in the top part of the figure a schematic diagram of a fourth exemplary embodiment of a motor vehicle light with a lens and light guides, and in the bottom part of the figure a timing diagram according to an embodiment of the method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

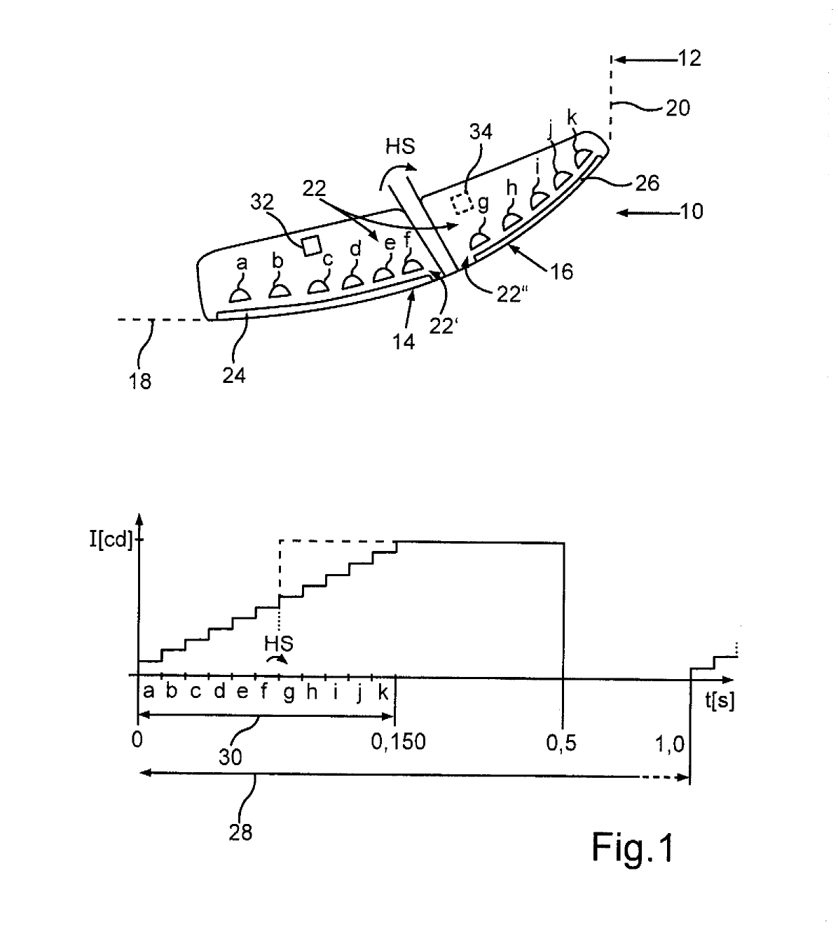

Turning now to the drawing, and in particular to FIG. 1, there is shown a motor vehicle light 10 installed, for example, in a road vehicle 12, for example in a passenger car. The motor vehicle light 10 may be, for example, a front headlamps with integrated turn signal and daytime running light or a tail light with integrated brake light, tail light and turn signal. The motor vehicle light 10 may be constructed from two structurally separate parts 14, 16. The part 14 may be installed in a rear gate 18 which is a part 16 in a side wall 20 of the motor vehicle 12. FIG. 1 shows a row 22 of light-emitting diodes a to k of the vehicle light 10. The row 22 of the light-emitting diodes a to k is part of a flashing light for a turn signal. Light from the light-emitting diodes a to k may exit from the vehicle light 10 through respective transparent lenses 24, 26 of the parts 14 and 16.

To produce a flashing light signal for a turn signal for other road users with the motor vehicle light 10, a control signal is transmitted from an (unillustrated) control unit of the motor vehicle 12 to the motor vehicle light 10. The control signal may, for example, be a simple pulse train with a period in a range of 650 ms to 2 s. The flashing light is then flashing with a frequency between 1.5 Hz and 0.5 Hz. In the present example, it is assumed that one flashing cycle 28 has a duration of 1 s. FIG. 1 shows how the light-emitting diodes a to k are turned on during a light-up phase 30 not simultaneously, but instead sequentially. The time axis in the diagram shown in FIG. 1 indicates the times at which the individual light-emitting diodes a to k are switched on during light-up phase 30. A light intensity I measured over the entire exit face of the lenses 24 and 26 then increases gradually. The light-up phase 30 may last, for example, 150 ms. The time offset between the turn-on of the individual light-emitting diodes a to k is so small that the stepwise increase in the overall brightness or luminous intensity I is not perceptible for a human observer of the vehicle light 10. Instead, the observer perceives a continuously widening row of illuminated light-emitting diodes a to k.

The control signal of the control unit, which specifies only the duration of the on- and off-phase, can be converted into the switching sequence for the individual light-emitting diodes a to k by microcontroller 32, 34 of the motor vehicle light 10. In order to obtain a smooth transition in the light-up phase between the partial row 22′ of the part 14 and the partial row 22″ of the part 16 of the motor vehicle light 10, a handshake signal HS is transmitted from the part 14 to the part 16 after the light-emitting diode f is switched on. This triggers turn-on of the light-emitting diode g and the additional light-emitting diodes h to k.

Not all the light-emitting diodes a to k may be sequentially turned on in the motor vehicle light 10. For example, the light-emitting diodes g to k of the partial row 22″ may be combined into an end group in the part 16 of the motor vehicle light 10, so that the light-emitting diodes g to k are always switched on and/or off together, i.e. at the same time. The microcontroller 34 in the part 16 may then be eliminated. The resulting alternative timing pattern of the light intensity I is shown the diagram by a dashed line. This operating mode has the advantage that, when the tailgate 18 is open, the part 16 appears as a conventional flashing turn signal.

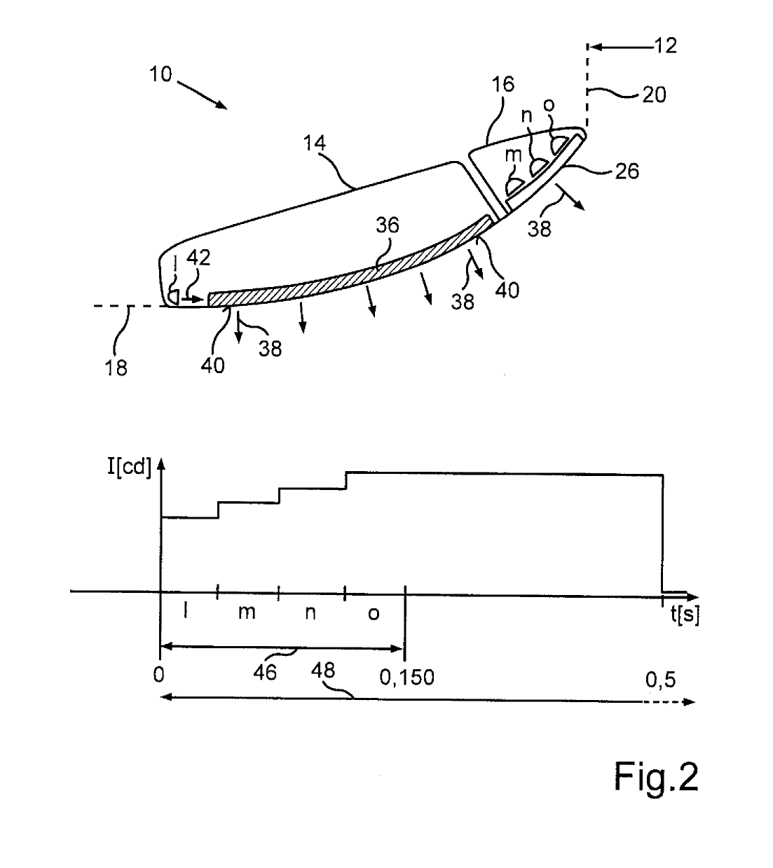

Additional embodiments of an inventive turn signal are described below with reference to FIGS. 2 to 4. Elements which having the same functional elements as those shown in FIG. 1 are designated in FIG. 2 to FIG. 4 with the same reference numerals as in FIG. 1. These elements are therefore also not explained again for the following figures.

FIG. 2 shows a motor vehicle light 10 which is constructed from two parts 14, 16. A turn signal of the motor vehicle light 10 is shown. The turn signal includes in the area of the part 14 a light-emitting diode l and an optical fiber 36. Part of the turn signals are also additional light-emitting diodes m, n, o and a transparent lens 26. The light from the light-emitting diodes l to o spreads after exiting from the motor vehicle light 10 in a solid angle range, which is indicated in FIG. 2 by corresponding exit directions 38. Only a few of the directional arrows are provided with reference numbers for sake of clarity.

The light-emitting diode l emits its light transversely in relation to a light exit face 40 of the part 14. A main emission direction 42 of light-emitting diode l is indicated in FIG. 2. The main emission direction 42 is oriented nearly parallel to the course of the light exit face 40. The light exit face 40 is part of the light guide 36. The light from the light-emitting diode l is coupled into the light guide 36 and one side of the light guide 36 and is distributed inside the light guide 36 along the exit face 40 of the light guide 36, i.e. parallel to the exit face 40, over a longitudinal extent of the light guide 36 by internal reflection. The light is scattered along the exit surface 40 in the exit direction 38 in uniform proportions. Spreading may be accomplished, for example, by interlocking a surface of the light conductor 36. The exit surface 40 then appears to an observer of the motor vehicle light 10 as uniformly bright during operation of the light-emitting diode l. The diagram shown in FIG. 2 illustrates the temporal course of a light intensity I of the motor vehicle light 10 during the light-up phase 46 of one flashing cycle 48 of the motor vehicle light 10. The luminous intensity I is here determined again across the entire light exit face, which is composed of the exit face 40 and the surface of the lens 26 (overall brightness).

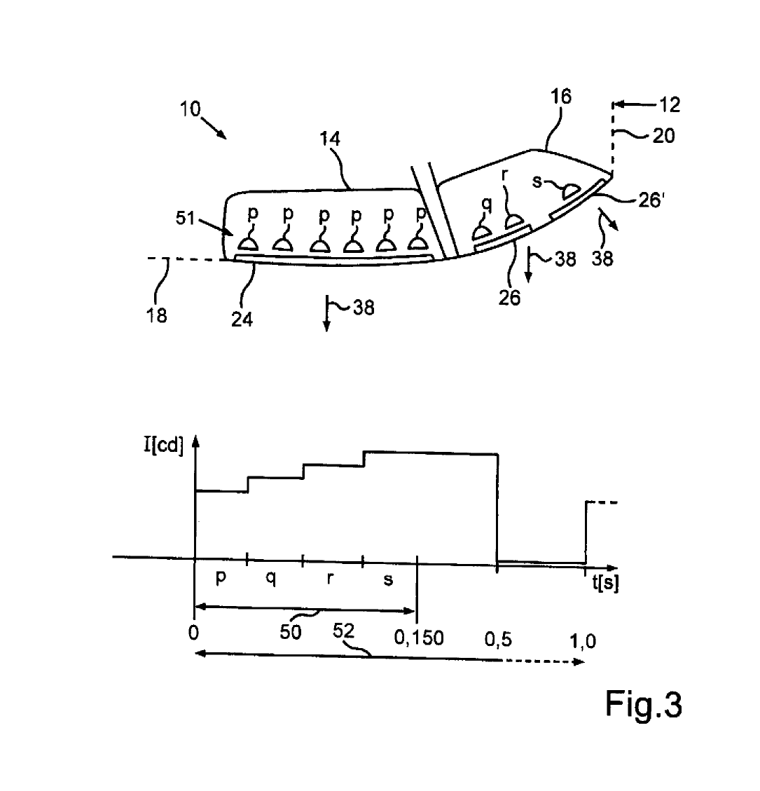

FIG. 3 shows a motor vehicle light 10 with the structure similar to that of the motor vehicle light of FIG. 1. In the vehicle light 10 of FIG. 3, the light-emitting diodes arranged in a row p of a part 14 of the motor vehicle light 10 disposed, for example, in a trunk lid 18 are turned on together at the same time as an initial group 51 at the beginning of a light-up phase 50 of a flashing cycle 52. Thereafter, additional light-emitting diodes q, r, s, which are located for example in a part 16 that is structurally separate from part 14, for example in a side wall 20 of the motor vehicle 12, are switched on. The temporal course of the light intensity I of the motor vehicle light 10 determined over the entire light exit face of lenses 24, 26, 26′ is also shown in FIG. 3 in form of a diagram.

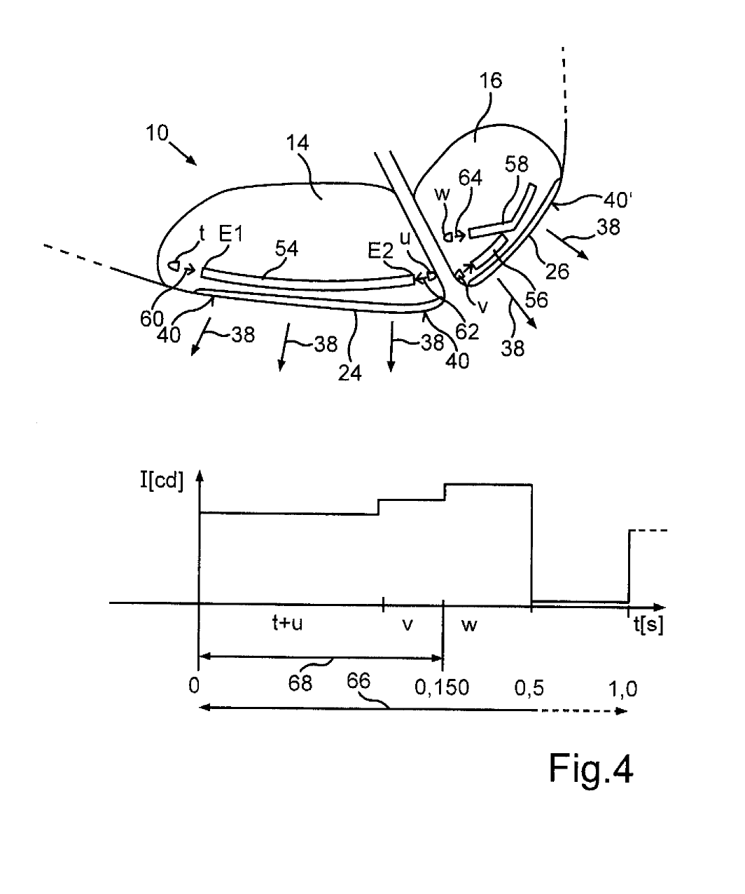

FIG. 4 shows a motor vehicle light 10 composed of two structurally distinct parts 14, 16. Light guide 54, 56, 58 are arranged behind transparent lenses 24, 26. The light guide 54 has an elongated shape and extends parallel to the longitudinal direction of the lens 24. Light from the light-emitting diodes t, u is coupled into the light guide 54 at respective ends E1, E2 of the light guide 54. For this purpose, the main radiation directions 60, 62 of the light-emitting diodes t, u are oriented towards the respective end of E1, E2 that receives the light. The main emission directions 60, 62 are thus oriented transversely to the lens 24. The light coupled into the light guide 54 is distributed by the light guide light 54 along the lens 24 having the light exit face 40 and thereby scattered proportionately into the light exit directions 38 toward the lens 24.

The light guide 58 has an elongated, angled shape. A main emission direction of a light-emitting diode w is oriented toward one end of the light guide 58. The major part of the light emitted by the light-emitting diode w is coupled into the light guide 58 and is distributed by the light guide 58 along the lens 26. Here, the light guide 58 scatters the light in a part of its angular shape extending parallel to the scattering lens 26 proportionately into the emitting directions 38 in the region of the light guide 58. The emission direction 64, into which the light from the light-emitting diode w is scattered, and a light exit face 40′ of the lens 26 include an angle having a magnitude less than 50°.

FIG. 4 shows in form of a diagram of a temporal course of a light intensity I produced during a single flashing cycle 66 of a turn signal formed by the light-emitting diodes t to w and the light guides 54 to 58. In a light-up phase 68 the light-emitting diodes are sequentially switched on, wherein first the light-emitting diodes t and u are simultaneously turned on as an initial group, with the light-emitting diodes v and w being subsequently switched on one after the other. The light-up phase 68 in this example has an overall duration of 150 ms.

The light-emitting diodes a to f may emit, for example, white light or yellow light. The lenses 24, 26, 26′ may be clear or colored. The light guides 36, 54, 56, 58 can also be made of a clear material or a colored material. The material may, for example, be PMMA. They can spread their light over an area of, for example, 4 cm² or more.

With the light-up phases 30, 46, 50, 68 each lasting less than 200 ms, here 150 ms, that legal requirements with respect to prohibiting a moving light are fully met. Nevertheless, additional direction information within the framework of the requirements is integrated by switching the light-emitting diodes on one after the other. By connecting light-emitting diodes in groups (light-emitting diodes p) or illuminating wide sections of the motor vehicle light uniformly by the light guides 36 and 54, the conventional behavior of a turn signal is obtained for these parts of the motor vehicle light 10. The additional directional information is added during the light-up phases via the adjoining parts, which are preferably arranged on a lateral edge of a rear section or a front section of the vehicle. This additional directional information is added to the known light bulbs durations of about 150 ms. The illustrated examples have been evaluated in physiological studies to be particularly suitable.

In summary, the examples demonstrate how additional information can be integrated in a turn signal for a motor vehicle, and how a bottom dynamic turn-on phase can be provided with a daytime running light, a position light and a tail light.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle light, comprising:
a light source producing light,
a light exit face through which the produced light is emitted to the outside, and
a light guide made of a transparent material and configured to receive at least a portion of the light from the light source, to distribute the received light along the light exit face, and to scatter the distributed light toward the light exit face.

2. The motor vehicle light of claim 1, wherein the light source has a main radiation direction in which the produced light is emitted with maximum intensity, with the main radiation direction enclosing an angle in a range from 0° to 50° with the light exit face.

3. The motor vehicle light of claim 2, wherein the enclosed angle is in a range from 0° to 30°.

4. The motor vehicle light of claim 1, further comprising a lens which includes the light exit face and delimits the motor vehicle light to the outside, and wherein the light guide comprises a body made of a material transparent to the light.

5. The motor vehicle light of claim 1, comprising two light sources, with light from the two light sources being introduced into the light guide at two different ends of the light guide.

6. The motor vehicle light of claim 1, comprising a plurality of light guides configured for introduction of light from at least one light source.

7. The motor vehicle light of claim 1, wherein the motor vehicle light provides at least one of the following features: direction indication, daytime running light, position light, tail light, and brake light

8. A method for operating a motor vehicle light, comprising:
increasing during a light-up phase a total light intensity, which is emitted in by the motor vehicle light through a designated total light exit face, so as to appear continuous to a human observer by at least one of two processes:
a) successively switching on a plurality of light-emitting diodes of the motor vehicle light, and
b) initially supplying a plurality of light-emitting diodes with different levels of electric power and subsequently controllably adjusting the electric power to match the brightness of the plurality of the light-emitting diodes to one another.

9. The method of claim 8, wherein the light-up phase has a duration in a range from 100 ms to 200 ms.

10. The method of claim 8, wherein the light-up phase has a duration in a range from 100 ms to 160 ms.

11. The method of claim 8, wherein the light-emitting diodes are successively turned on during the light-up phase, thereby continuously increasing during the light-up phase an illuminated portion of the entire light exit face.

12. The method of claim 11, wherein the illuminated portion of the entire light exit face is spatially contiguous.

13. The method of claim 8, wherein the motor vehicle light is operated as a flasher light, the method comprising the steps of:
at the beginning of at least one flashing cycle, switching on light-emitting diodes arranged in a row,
in the light-up phase of the at least one flashing cycle, starting from a least one initial group which includes at least one of the light-emitting diodes of the row, sequentially switching on additional light-emitting diodes of the row either individually or in groups formed by adjacent light-emitting diodes, and
terminating the light-up phase by switching on an end group comprising at least one light-emitting diode of the row,
thereby illuminating all light-emitting diodes of the row.

14. The method of claim 13, wherein the row of light-emitting diodes extends over at least two structurally separate parts of the motor vehicle light and all light-emitting diodes of the row located in one of the two parts are operated as the at least one initial group or the end group.

15. The method of claim 13, wherein one of the two parts of the motor vehicle light is configured for incorporation into a tailgate of a motor vehicle and another part of the motor vehicle light is configured for incorporation in a region of the motor vehicle adjacent to the tailgate.

16. The method of claim 14, further comprising the steps of:
transmitting a handshake signal between adjacent ones of the at least two structurally separate parts of the motor vehicle light, after all light-emitting diodes of one of the adjacent parts have been switched on, and
causing the light-emitting diodes of the other of the adjacent parts to be switched on with the handshake signal.

17. A motor vehicle light, comprising
a light source producing light,
a light exit face through which the produced light is emitted to the outside,
a light guide made of a transparent material and configured to receive at least a portion of the light from the light source, to distribute the received light along the light exit face, and to scatter the distributed light toward the light exit face, and
a control unit which is configured to operate the motor vehicle light by:
increasing during a light-up phase a total light intensity, which is emitted in by the motor vehicle light through a designated total light exit face, so as to appear continuous to a human observer by at least one of two processes:
a) successively switching on a plurality of light-emitting diodes of the motor vehicle light, and
b) initially supplying a plurality of light-emitting diodes with different levels of electric power and subsequently controllably adjusting the electric power to match the brightness of the plurality of the light-emitting diodes to one another.

18. A motor vehicle, comprising
at least one motor vehicle light having
a light source producing light,
a light exit face through which the produced light is emitted to the outside,
a light guide made of a transparent material and configured to receive at least a portion of the light from the light source, to distribute the received light along the light exit face, and to scatter the distributed light toward the light exit face, and
a control unit which configured to operate the motor vehicle light by increasing during a light-up phase a total light intensity, which is emitted in by the motor vehicle light through a designated total light exit face, so as to appear continuous to a human observer by at least one of two processes:
a) successively switching on a plurality of light-emitting diodes of the motor vehicle light, and
b) initially supplying a plurality of light-emitting diodes with different levels of electric power and subsequently controllably adjusting the , electric power to match the brightness of the plurality of the light-emitting diodes to one another.
